(19) United States
(12) Patent Application Publication
(10) Pub. No.: US 2024/0190183 A1
(43) Pub. Date: Jun. 13, 2024

(54) PNEUMATIC TIRE

(71) Applicant: Toyo Tire Corporation, Itami-shi (JP)

(72) Inventor: Yoshiki Sato, Itami-shi (JP)

(73) Assignee: Toyo Tire Corporation, Itami-shi (JP)

(21) Appl. No.: 18/527,737

(22) Filed: Dec. 4, 2023

(30) Foreign Application Priority Data
Dec. 8, 2022 (JP) 2022-196347

(51) Int. Cl. B60C 13/00

(52) U.S. Cl. CPC B60C 13/001

(57) ABSTRACT

A tire includes at least one mark on a sidewall of the tire. The mark has an outer surface including a bottom face of a single recess between two slope faces tapered into a valley shape. One or more circular protrusions protruding axially outward may be disposed around the entire edge of the mark, and the mark may be fringed with the circular protrusions. The recess may have a bottom (line of intersection) extending in a direction slanted at 10° or less relative to a radial direction of the mark.

### CROSS REFERENCE TO RELATED APPLICATION

This application claims priority to Japanese Patent Application No. 2022-196347 filed on Dec. 8, 2022, which is incorporated herein by reference in its entirety including the specification, claims, drawings, and abstract.

### TECHNICAL FIELD

The present disclosure relates to a pneumatic tire.

### BACKGROUND

A pneumatic tire disclosed in JP 2019-147495 A is known. The pneumatic tire includes a mark disposed on a sidewall face of the tire, and the mark at least partially includes saw-tooth serrations of a plurality of ridges arranged in parallel. This pneumatic tire, including the mark having serrations with short pitches and different angles, allows light that irradiates the mark to be reflected in many different directions. This generates variations of light and shadow parts on the mark to thereby allow the mark to be conspicuous.

### SUMMARY

In the above-described pneumatic tire, the mark having serrations with short pitches is likely to be clogged with mud while the vehicle is traveling on a muddy road. This deteriorates legibility of characters and also makes it difficult to clean off the dirt from the tire. An embodiment of the disclosure is therefore aimed toward providing a pneumatic tire having a conspicuous mark which is not easily clogged with mud.

To resolve the above problem, the pneumatic tire according to the present disclosure includes at least one mark on a sidewall of the pneumatic tire, and the at least one mark includes an outer surface including a bottom face of only one recess composed of two slope faces tapered into a valley shape. Each slope face may be one flat face, a smooth slope face, or a face including a flat face and a smoothly curved line. The slope face may be any face that is inclined axially inward of the tire as the slope face extends toward the valley located at an axially innermost site of the tire.

The configuration of the pneumatic tire according to the present disclosure allows a mark to look conspicuous while preventing the mark from being easily clogged with mud.

### BRIEF DESCRIPTION OF DRAWINGS

The figures depict one or more implementations in accordance with the present teaching, by way of example only, not by way of limitations. In the figures, like reference numerals refer to the same or similar elements.

Embodiments of the present disclosure will be described based on the following figures, wherein:

FIG. 1 is a perspective view of a tire according to one embodiment of the disclosure, illustrating one side of the tire viewed from diagonally above;

FIG. 2 is a perspective view of a mark display region when viewed from diagonally below in the axially outward direction;

FIG. 3 is a schematic cross-sectional view of part of a mark when cut with a plane orthogonal to a plane including an intersection line between a first slope face and a second slope face and an axial direction of a tire;

FIG. 4 is a perspective sectional view of the mark display region taken along line A-A in FIG. 2, which illustrates a configuration created by cutting the mark display region with a combined plane composed of planes each passing a center along an extending direction of a straight-line extending site located at one circumferential end (left side on a sheet) of each of the marks disposed on the mark display region, each plane orthogonal to the straight-line extending site, when viewed in a slightly slanted axial direction;

FIG. 5 is a perspective view illustrating a peripheral region of a mark representing E in a tire according to a first modification example;

FIG. 6 is a perspective view of a tire according to a second modification example, corresponding to FIG. 2;

FIG. 7 is a schematic cross-sectional view of a tire according to a third modification example, corresponding to FIG. 3;

FIG. 8 is a schematic cross-sectional view of a tire according to a fourth modification example, corresponding to FIG. 3;

FIG. 9 is a schematic cross-sectional view of a tire according to a fifth modification example, corresponding to FIG. 3; and

FIG. 10 is a schematic cross-sectional view of a tire according to a sixth modification example, corresponding to FIG. 3.

### DESCRIPTION OF EMBODIMENTS

Embodiments of the disclosure will be described in detail below by reference to the drawings. It is expected that, features of a plurality of embodiments and modification examples described below may be combined as appropriate to constitute new embodiments. In the following examples, identical elements are denoted with the same reference numerals and will not be explained repeatedly. A plurality of drawings include schematic views, and the dimensional ratios among the vertical length, horizontal length, and height, for example, of marks in different drawings are not always the same. Among the elements described below, elements that are not recited in independent claims representing the most superordinate concept are optional, not essential. In the following description, a “pneumatic tire” will be simply referred to as a “tire”. Further, the outer surface of a mark, which will be described below, includes a bottom face of only one recess composed of two slope faces tapered into a valley. Here, a bottom face of a recess refers to a face that constitutes the recess. Each slope face may be a single flat face, a smooth slope face, or a face including a flat face and a smooth curved line connected together. The slope face may be any face that is inclined axially inward of the tire as the slope face extends toward the valley located at the axially innermost site of the tire.

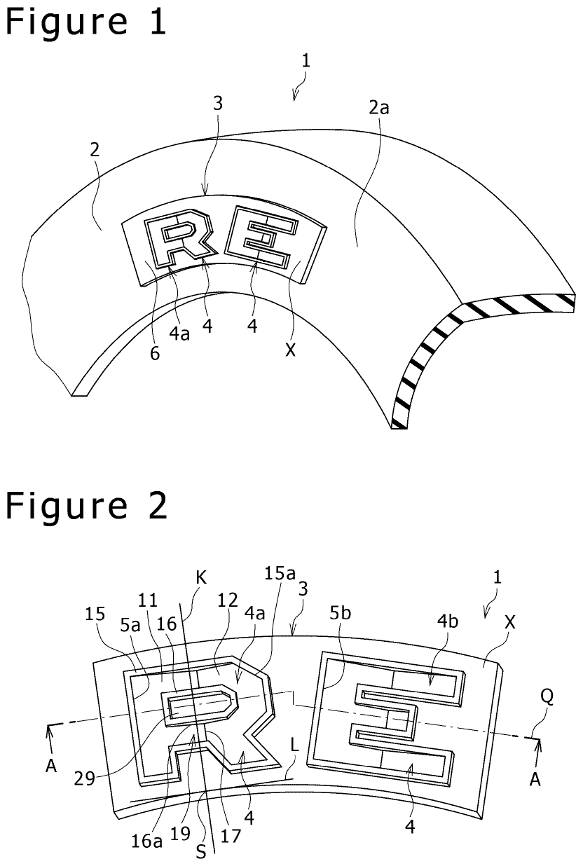

FIG. 1 is a perspective view of a tire 1 according to an embodiment of the disclosure, and illustrates one side of the tire 1 viewed from diagonally above. As illustrated in FIG. 1, the tire 1 includes at least one mark display region 3 on at least one sidewall 2. The sidewall 2 is on a side of the tire 1, and has a site where the tire 1 is most flexible. The sidewall 2 is smoothly bendable and is resistant to impacts and a centrifugal force.

The mark display region 3 includes a base face X on a top face 2a of the sidewall 2, and one or more marks 4 disposed on the base face X. The mark display region 3 has a seat 6 protruding from the top face 2a of the sidewall 2 to a predetermined height, and a top surface of the seat 6 functions as the base face X. The thickness direction of the seat 6 substantially corresponds to the axial direction of the tire 1.

The seat 6 may be omitted; in this configuration, the top face 2a of the sidewall 2 functions as the base face X. The mark 4 includes characters, such as characters representing the name of the manufacturer, brand name, tire size, aspect ratio, week of the year of manufacture of the tire, or includes symbols such as speed signs and figures. In this embodiment, a brand name including a plurality of marks 4 is shown on the base face X.

FIG. 2 is a perspective view of the mark display region 3 viewed from diagonally below in the axially outward direction. As illustrated in FIG. 2, the outer surface of the mark 4 is composed of a bottom face of only one recess 19 formed of two slope faces 11 and 12 that are inclined or tapered into a valley or V shape. More specifically, in this embodiment, the first slope face 11 and the second slope face 12 are both flat faces extending in different directions. A line of intersection 17 between the first slope face 11 and the slope face 12 extends substantially radially, and more specifically, extends in a direction slanted at 10° or less relative to the radial direction of the mark 4. In this disclosure, the radial direction of the mark 4 is defined as a radial direction K of the tire 1 that passes a circumferential center position S between a first circumferential edge and a second circumferential edge of the mark 4 in a plan view of the tire 1 viewed axially from axially outward. The line of intersection 17 lies in a valley of the recess 19, which is at the deepest location in the recess 19.

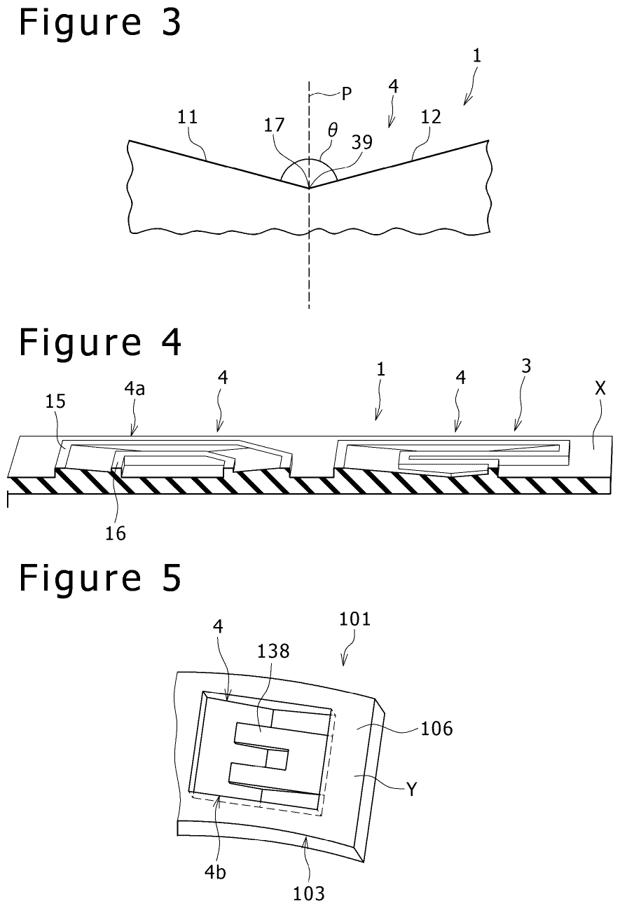

FIG. 3 is a schematic cross-sectional view of a part of the mark 4 that is cut with a plane orthogonal to a plane P including the line of intersection 17 between the first slope face 11 and the second slope face 12 and the axial direction of the tire 1 (corresponding to the thickness of the seat 6 in this embodiment). As illustrated in FIG. 3, the first slope face 11 shifts axially outward of the tire 1 as the first slope face 11 extends away from line of intersection 17 toward a first side in the orthogonal direction orthogonal to the plane P. The second slope face 12 shifts axially outward of the tire 1 as the second slope face 12 extends away from line of intersection 17 toward a second side in the orthogonal direction orthogonal to the plane P. The first slope face 11 and the second slope face 12 are inclined at substantially the same angle with respect to the plane P.

Known tires include marks that protrude axially outward on the sidewall to make the marks conspicuous, and there has not been known the contrary idea of novel display of the mark 4 represented by a recess expressed with two slope faces. In such a background, the angle θ between the first slope face 11 and the second slope face 12 may be any angle in the range of 0°<θ<180°. However, a mark with θ being 177° or less facilitates humans' recognition of the recess display and is likely to attract human attention by expression with the recess display that is full of originality, and a mark with θ being 175° or less further facilitates humans' recognition of the recess display and is more likely to attract human attention by expression with the recess display that is full of originality. Further, a mark with θ being 171° or more attracts human attention and also provides good mud-ejection property, and a mark with θ being 173° or more further attracts human attention and also provides better mud-ejection property. A mark with θ being 174° facilitates humans' recognition of the recess display, is likely to attract human attention by expression with the recess display that is full of originality, and also provides enhanced mud-ejection property. Therefore, the angle θ is 174° in this embodiment.

FIG. 4 is a perspective sectional view of the mark display region 3 taken along line A-A in FIG. 2, and illustrates a configuration created by cutting the mark display region 3 with a combined plane Q, when viewed in a slightly slanted axial direction. The combined plane Q includes planes each of which passes a center, along an extending direction, of a straight-line extending site 5a, 5b located at one circumferential end (left side on the sheet) of each mark 4a, 4b disposed on the mark display region 3, and which is also orthogonal to the straight-line extending site 5a, 5b.

As illustrated in FIG. 2, the mark 4 includes, at the entire edges, circular protrusions 15 and 16 protruding axially outward to fringe the mark 4. The mark 4a representing R includes an outer circular protrusion 15 fringing the entire circumference of an outer edge 15a, and an inner circular protrusion 16 fringing the entire circumference of an inner edge 16a. The outer circular protrusion 15 and the inner circular protrusion 16 are included in the one or more circular protrusions disposed on the mark 4 and protruding axially outward. Referring to FIG. 2, the axial length obtained by subtracting the axial position of the line of intersection 17 at the deepest site in the mark 4 from the axial position of the one or more circular protrusions 15 and 16 at the axially outermost site may have an arbitrary value. However, the mark 4 with this value being 1 mm or more provides an enhanced aesthetical view of the mark 4, thereby achieving a novel and stylish mark 4, and the mark 4 with this value being 3 mm or less provides an increased mud-ejection property.

In a mark including the circular inner edge 16a such as the mark 4a representing R, the axial position of the outer surface of a region 29 enclosed with the inner edger 16a is located further axially outward than the axial position of the line of intersection 17 at the deepest site in the mark 4. However, the axial position of the outer surface of the region 29 enclosed with the inner edger 16a may be level with the axial position of the base face X.

FIG. 5 is a perspective view illustrating a peripheral region of the mark 4b representing E in a tire 101 according to a first modification example. As illustrated in FIG. 5, a mark display region 103 disposed on the sidewall includes a seat 106 protruding from the top face of the sidewall to a predetermined height, and the top face of the seat 106 functions as a base face Y.

The seat 106 includes a depression 138 having a substantially constant depth, and one or more marks 4 are disposed on the bottom face of the depression 138. The seat 106 may be omitted; in this configuration, the top face of the sidewall functions as the base face Y, and the top face of the sidewall includes the depression 138 having substantially a constant depth and one or more marks 4, 4b are disposed on the bottom face of the depression 138. In the tire 101 of this modification example, the mark 4b is disposed on the bottom face of the depression 138, and further, the bottom face of the depression 138 is part of the mark 4, 4b. This configuration achieves noticeable originality of the mark 4, 4b and achieves the attractive mark 4, 4b.

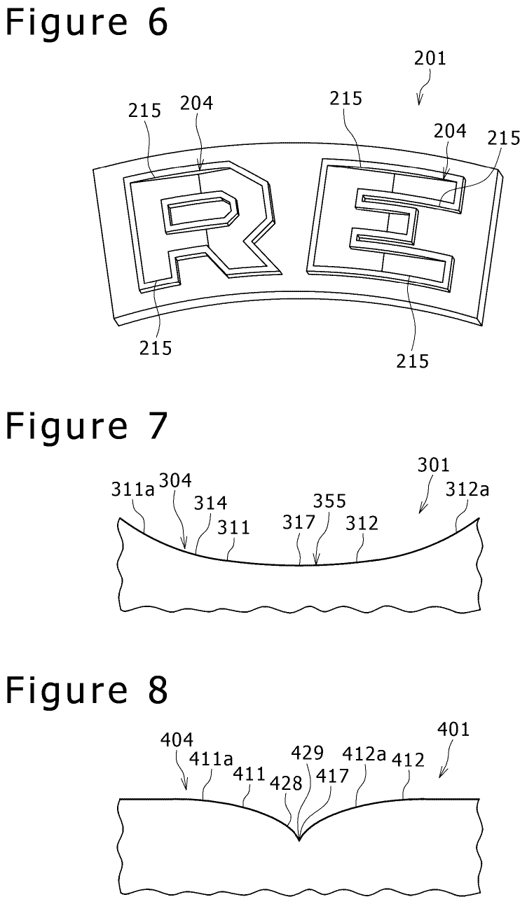

FIG. 6 is a perspective view of a tire 201 according to a second modification example, which corresponds to FIG. 2. As illustrated in FIG. 6, a mark 204 may have an arc-shaped edge 215 extending parallel to the circumferential direction of the tire 201.

FIG. 7 is a schematic cross-sectional view of a tire 301 according to a third modification example, which corresponds to FIG. 3, and FIG. 8 is a schematic cross-sectional view of a tire 401 according to a fourth modification example, which corresponds to FIG. 3. As illustrated in FIG. 7, two slope faces 311 and 312 that are inclined or tapered into a valley to constitute the outer surface of a mark 304 may each be a single curved face 311a, 312a protruding or curving axially inward and free of a protrusion rising axially outward. Further, the two slope faces 311 and 312 may be connected smoothly at a line of intersection (the position of the valley at the axially innermost site) 317. The outer surface 314 of the mark 304 constituted by a combination of the two slope faces 311 and 312 may be composed of a single curved face 355.

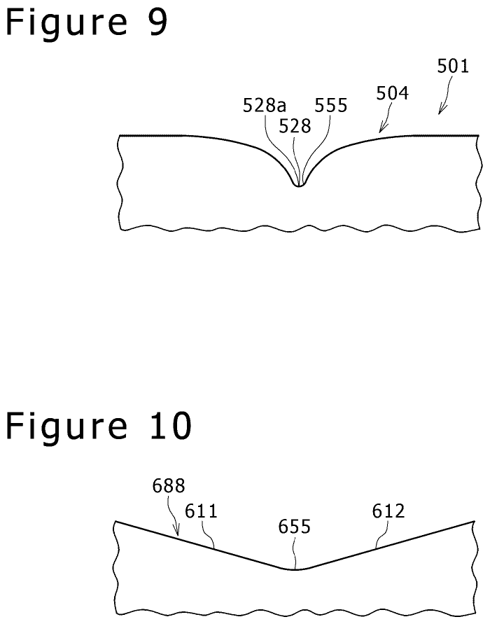

As illustrated in FIG. 8, two slope faces 411 and 412 that are inclined or tapered into a valley to form the outer surface of a mark 404 may each be a single curved face 411a, 412a protruding or curving axially outward and free of a protrusion rising axially outward. Further, a groove 428 may be formed at a site including a line of intersection 417 of the two curved faces 411a and 412a. In this configuration, a corner 429 may be present at the line of intersection 417. Alternatively, as illustrated in FIG. 9 that is a schematic cross-sectional view of a tire 501 according to a fifth modification example, which corresponds to FIG. 3, a groove 528 may have a bottom 528a including a curved face 555 protruding axially inward, and no corners may be present in the vicinity of the bottom of the groove 528.

The tires 401 and 501 according to the fourth and fifth modification examples, respectively, include the groove 428, 528 created where the two slope faces 411 and 412, 511 and 512, are connected, and shadow is generated at the groove 428, 528. This configuration achieves a further novel and stylish mark 404, 504. In particular, the tire 501 according to the fifth modification example including no corners in the vicinity of the groove 528 has an increased anti-cracking properties in the vicinity of the groove 528.

### Basic Configurations

The tire 1, 101, 201, 301, 401, 501 includes one or more marks 4, 4a, 4b, 304, 404, 504 on the sidewall 2. The outer surface of the mark 4, 4a, 4b, 204, 304, 404, 504 includes a bottom face of only one recess 19 composed of the two slope faces 11 and 12, 311 and 312, 411 and 412, 511 and 512, inclined or tapered into a valley or a V-shape.

The mark 4, 4a, 4b, 204, 304, 404, 504 according to the disclosure is composed of the two slope faces 11 and 12, 311 and 312, 411 and 412, 511 and 512, inclined or tapered into a valley or a V-shape, and therefore includes the much smaller number of faces than the mark disclosed in JP 2019-147495 A, or a mark having serrations with short pitches and different angles. This configuration enables reduction in clogging of the mark 4, 204 with mud.

As described above, the mark 4, 4a, 4b, 204, 304, 404, 504 is composed of the two slope faces 11 and 12, 311 and 312, 411 and 412, 511 and 512, inclined or tapered into a valley or a V-shape. Thus, the mark 4, 4a, 4b, 204, 304, 404, 504 is expressed by the recess 19, which is a method that is contrary to the conventional method of expressing marks with protrusions, and this configuration makes the mark 4, 4a, 4b, 204, 304, 404, 504 original and novel, attracting humans' attention by the conspicuous mark 4, 4a, 4b, 204, 304, 404, 504.

### Optional Configurations

As illustrated in FIGS. 1, 2, 4, and 6, the one or more circular protrusion 15 and 16 protruding axially outward may be disposed around the entire edges of the mark 4, 204 to allow the mark 4, 204 to be fringed with the circular protrusions 15 and 16.

This configuration of the mark 4, 204 having the entire edges fringed with the circular protrusions 15 and 16 allows the inner face of the circular protrusions 15 and 16 facing the mark 4, 204 to create a step. This makes the mark 4, 204 conspicuous, and increases legibility of the mark 4, 204.

Further, as illustrated in FIG. 5, the sidewall may include the base face Y and the depression 138 on the base face Y, and the mark 4, 4b may be disposed at the bottom face of the depression 138.

This configuration including the mark 4, 4b disposed on the bottom face of the depression 138, and the bottom face of the depression 138 constituting the mark 4, 4b itself, provides significant originality to the mark 4, 4b to achieve the attractive mark 4, 4b.

Further, the bottom (line of intersection 17) of the recess 19 may extend in a direction slanted at 10° or less relative to the radial direction of the mark 4.

This configuration allows the two slope faces 11 and 12, 311 and 312, 411 and 412, 511 and 512 to extend parallel to the circumferential direction or in a linear direction slanted by a slight angle relative to a tangent contacting circumferentially at any circumferential position. This facilitates human's recognition of the bottom (line of intersection 17, 317, 417) of the valley or V-shape, achieving significant originality of the mark.

Further, as illustrated in FIG. 6, the mark 204 having the arc-shaped edge 215 extending parallel to the circumferential direction of the tire 201 enhances design property of the mark 204 to thereby provide an enhanced aesthetic view of the mark 304.

### Other Modification Examples

The disclosure is not limited to the embodiments and modification examples described above, and various improvements and changes may be made within the scope of features described in the claims of the present application and its equivalent scope.

For example, the above embodiment includes a sharp-pointed V-shape groove 39 (see FIG. 3) in the vicinity of the line of intersection 17 between the first slope face 11 and the second slope face 12. However, as illustrated in FIG. 10, a first slope face 611 in a flat shape and a second slope face 612 in a flat shape may be connected smoothly across a curved face 655 protruding axially inward and disposed at a site including the valley position. In other words, a face 688 composed of two slope faces inclined or tapered into a V-shape and forming the outer surface of the mark may include the first slope face 611 in a flat shape, the second slope face 612 in a flat shape, and the curved face 655 protruding axially inward and smoothly connecting the first slope face 611 and the second slope face 612. This configuration increases anti-cracking properties in the vicinity of the valley.

Also, while in the above examples, the line of intersection (valley position) 17, 317, 417 extends in a direction slanted at 10° or less relative to the radial direction of the mark 4, 304, 404, the line of intersection (valley position) may extend in any direction and may extend parallel to the circumferential direction of the tire, for example. Referring to FIG. 2, the line of intersection (valley position) 17 may extend in a linear direction that is slanted at 10° or less relative to the circumferential tangent L at a center location P(S?) between a first circumferential end of the mark 4 and a second circumferential end of the mark 4. Here, the configuration including the line of intersection 17 that is slanted at 0° relative to the tangent L, or the configuration including the line of intersection 17 extending parallel to the tangent L, is included in the configuration including the line of intersection 17 that is slanted at 10° or less relative to the tangent L.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A pneumatic tire comprising:
at least one mark on a sidewall of the pneumatic tire,
the at least one mark including an outer surface including a bottom face of only one recess composed of two slope faces tapered into a valley shape.

2. The pneumatic tire according to claim 1, wherein
at least one circular protrusion protruding axially outward is disposed around an entire edge of the at least one mark to fringe the at least one mark.

3. The pneumatic tire according to claim 1, wherein
the sidewall includes a base face and a depression disposed on the base face, and
the at least one mark is disposed on a bottom face of the depression.

4. The pneumatic tire according to claim 1, wherein
the recess has a bottom extending in a direction that is slanted at 10° or less relative to a radial direction of the at least one mark.

5. The pneumatic tire according to claim 2, wherein
the one or more circular protrusions include an outer circular protrusion that fringes an outer edge of the mark around an entire circumference and an inner circular protrusion that fringes an inner edge of the mark around an entire circumference.

6. The pneumatic tire according to claim 1, wherein
a first slope face of the two slope faces and a second slope face of the two slope faces are flat faces, and the first slope face and the second slope face form an angle of 171° or greater and 177° or smaller.

7. The pneumatic tire according to claim 2, wherein
an axial length obtained by subtracting an axial position of a line of intersection at a deepest location in the mark from an axial position of the one or more circular protrusions at an axially outermost site is 1 mm or greater and 3 mm or smaller.

8. The pneumatic tire according to claim 1, wherein
the at least one mark comprises an arc-shaped edge extending parallel to a circumferential direction.

9. The pneumatic tire according to claim 1, wherein
each of the two slope faces is a single curved face protruding axially inward,
the two slope faces are smoothly connected at a location of the valley, and
the outer surface of the at least one mark that is a combination of the two slope faces is a single curved face.

10. The pneumatic tire according to claim 1, wherein
each of the two slope faces is a single curved face protruding axially outward,
the outer surface of the at least one mark includes a groove at a site including a line of intersection of the two curved faces, and
a corner is present at a site where the line of intersection is present.

11. The pneumatic tire according to claim 1, wherein
each of the two slope faces is a single curved face protruding axially outward,
the outer surface of the at least one mark includes a groove at a site including a line of intersection of the two curved faces, and
the groove has a bottom included in a curved face protruding axially inward.

12. The pneumatic tire according to claim 1, wherein
the two slope faces comprise a face including a first slope face that is a flat face, a second slope face that is a flat face, and a curved face protruding axially inward and smoothly connecting the first slope face and the second slope face.

13. The pneumatic tire according to claim 1, wherein
a line of intersection between the two slope faces extends in a linear direction that is slanted at 10° or less relative to a circumferential tangent at a center between a first circumferential end of the mark and a second circumferential end of the mark.
